(19) United States
(12) Patent Application Publication
(10) Pub. No.: US 2011/0160097 A1
(43) Pub. Date: Jun. 30, 2011

(54) VISCOSIFYING POLYMERS AND METHODS OF USE

(76) Inventors: Amir A. MIRZAEI, Toronto (CA); Hirbod RAD, Calgary (CA)

(21) Appl. No.: 12/711,769

(22) Filed: Feb. 24, 2010

Related U.S. Application Data
(60) Provisional application No. 61/291,338, filed on Dec. 30, 2009.

(51) Int. Cl. C09K 8/24; C09K 8/588; C09K 8/62

(52) U.S. Cl. 507/117; 507/221

(57) ABSTRACT

Fluids for use within a wellbore are provided, comprising amorphous polyalphaolefins and/or amorphous polyisobutylene in an oil-based hydrocarbon solvent. Novel properties of such fluids are described, and the fluids may be used, for example, during drilling or fracturing operations.

### CONTINUITY DATA

This application claims the benefit of priority from U.S. provisional patent application 61/291,338, filed Dec. 30, 2009.

### FIELD OF THE INVENTION

The present invention relates generally to oil gellants and viscosifiers for use in the oil and gas industry. More particularly, the present invention relates to polymers for use in the gelling and viscosification of drilling and fracturing fluids.

### BACKGROUND OF THE INVENTION

In the field of drilling, completion, and workover of oil and gas wells, various fluids are formulated for use in different circumstances and types of formations. For example, drilling fluids may vary in composition over a wide spectrum and are formulated to maintain pressure, cool drill bits, and lift cuttings from the borehole. Fracturing fluids are formulated to stimulate the formation through artificially induced fractures. Generally, drilling or fracturing fluids are based on aqueous formulations or oil-based formulations.

Typical oil-based drilling fluids may include additives such as emulsifying agents, wetting agents, water, fluid-loss additives or fluid-loss control agents, weighting agents, and gelling or viscosifying agents (for example organophilic clays). These formulations perform adequately in a number of applications, and the formulation may be adjusted based on the stability of the formation in which drilling is taking place. Oil-based fluids are particularly useful in shale formations, where the use of conventional water-based drilling fluids could result in the deterioration and collapse of the shale formation. The use of oil-based formulations circumvents this problem.

However, there are also significant disadvantages associated with oil-based drilling fluids in some circumstances. For example, use of organophilic clays may cause formation damage in sensitive formations by plugging pore throats and thereby reducing permeability and production.

With respect to fracturing treatment, fluid losses to the formation should be minimized. That is, the efficiency of the fluid (ratio of fracture volume created to pumped volume) should be high. At high shear rates, the viscosity of the fluid should be as low as possible to avoid excessive friction losses in the tubing resulting in high tubing-head pressures. However, the viscosity of the fluid should be sufficient for proppant transport in the tubing, in the fracture, during the pumping phase, and after pumping has stopped but before the fractures closes.

The permeability reduction of the proppant pad (and formation as a result of exposure to the fracturing fluid) should be small. Viscosity breakdown after the fracturing treatment should be consistently completed within a short period of time. (SPE Paper Number 23109-MS, 1991).

### SUMMARY OF THE INVENTION

In accordance with a first aspect of the invention, there is provided an oil-based fluid for use within a wellbore, the fluid comprising: 50 to 100% hydrocarbon-based oil (by volume); 0 to 50% water (by volume); and 25 ppm to 100,000 ppm of amorphous polyalphaolefins (APAO), the APAO having an average molecular weight of between 1,000,000 and 50,000,000.

In one embodiment, the hydrocarbon-based oil comprises paraffinic hydrocarbons, aromatic hydrocarbons, or naphthenic hydrocarbons.

In another embodiment, the hydrocarbon-based oil comprises up to 50% of non-solvent alcohols, vegetable oils or synthetic fluids (by volume).

In one embodiment, the concentration of APAO is between about 500 ppm and about 10,000 ppm.

In accordance with one embodiment, the average molecular weight of APAO is between about 5,000,000 and 25,000,000.

In an embodiment, the fluid further comprises an amount of amorphous polyisobutylene.

In an embodiment, the fluid is formulated for use as a drilling fluid, and may contain up to 99% hydrocarbon-based oil (by volume). The fluid may further comprise: a weighting material, a wetting agent, or an emulsifier.

In an embodiment, the fluid is formulated for use as a fracturing fluid, and may contain up to 100% hydrocarbon-based oil (by volume).

In accordance with a second aspect of the invention, there is provided an oil-based fluid for use within a wellbore, the fluid comprising: 50 to 100% hydrocarbon-based oil (by volume); 0 to 50% water (by volume); and 250 ppm to 100,000 ppm of amorphous polyisobutylene (APIB), the APIB having an average molecular weight of between 500,000 and 10,000,000.

In an embodiment, the hydrocarbon-based oil comprises paraffinic hydrocarbons, aromatic hydrocarbons, or naphthenic hydrocarbons.

In an embodiment, the hydrocarbon-based oil comprises up to 50% by volume of non-solvent alcohols, vegetable oils or synthetic fluids.

In an embodiment, the concentration of APIB is between about 500 ppm and about 5,000 ppm.

In an embodiment, the average molecular weight of APIB is between about 1,000,000 and 5,000,000.

In an embodiment, the fluid is formulated for use as a drilling fluid and comprises up to 99% hydrocarbon-based oil (by volume). The fluid may further comprise: a weighting material, a wetting agent, or an emulsifier.

In an embodiment, the fluid is formulated for use as a fracturing fluid, and comprises up to 100% hydrocarbon-based oil (by volume).

In accordance with a third aspect of the invention, there is provided a method for increasing the viscosity of an oil-based drilling fluid, the method comprising: providing an oil-based drilling fluid; and adding 25 ppm to 100,000 ppm of amorphous polyalphaolefins (APAO), the APAO having an average molecular weight of between 1,000,000 and 50,000,000.

In accordance with a fourth aspect of the invention, there is provided a method for increasing the viscosity of an oil based drilling fluid, the method comprising: providing an oil-based drilling fluid; and 250 ppm to 100,000 ppm of amorphous polyisobutylene (APIB), the APIB having an average molecular weight of between 500,000 and 10,000,000.

In accordance with a fifth aspect of the invention, there is provided a method for increasing the viscosity of an oil based fracturing fluid, the method comprising: providing an oil-based fracturing fluid; and adding 25 ppm to 100,000 ppm of amorphous polyalphaolefins (APAO), the APAO having an average molecular weight of between 1,000,000 and 50,000,000.

In accordance with another aspect of the invention, there is provided a method for increasing the viscosity of an oil based fracturing fluid, the method comprising: providing an oil-based fracturing fluid; and adding 250 ppm to 100,000 ppm of amorphous polyisobutylene (APIB) to the fracturing fluid, the APIB having an average molecular weight of between 500,000 and 10,000,000.

In accordance with a further aspect of the invention, there is provided a method for adjusting the viscosity of a fracturing fluid during fracturing treatment, the method comprising the steps of:
providing an oil based fracturing fluid;
adding 25 ppm to 100,000 ppm of amorphous polyalphaolefins (APAO) to the fracturing fluid, the APAO having an average molecular weight of between 1,000,000 and 50,000,000;
delivering the fracturing fluid downhole to a zone of interest; and

increasing the hydrostatic pressure of the fracturing fluid to break the APAO polymers, thereby reducing the viscosity of the fracturing fluid within the formation.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a line graph depicting rheological properties of an oil based drilling fluid with varying concentrations of polymer;

FIG. 2 is a bar graph depicting rheological properties of an oil based drilling fluid with varying concentrations under various conditions; and

FIG. 3 is a line graph depicting rheological properties before and after addition of polymer.

### DETAILED DESCRIPTION

Viscosifiers based on amorphous polyalphaolefins (APAO) and/or amorphous polyisobutylene (APIB) are provided for use in oil-based drilling and/or fracturing fluids. The resulting fluids show favourable viscosity characteristics and stability.

### Overview

An approach to viscosifying and gelling of oil-based drilling and fracturing fluids is provided which permits partial or total substitution of amorphous polyalphaolefins (APAO) and/or Amorphous Polyisobutylene (APIB) for organophilic clays, phosphate esters or other viscosifying materials typically used in drilling and fracturing formulations. The resulting polymer-modified drilling or fracturing fluids display notable advantageous properties, including viscosities in the appropriate range for drilling or fracturing operations.

The types of polymers that are contemplated in the present invention comprise any of the (ultra high molecular weight) amorphous oil-soluble polyalphaolefins (APAO). Such polymers, and methods for their manufacture, have been previously described. For example, APAOs may be produced by homopolymerization or copolymerization of α-olefins (e.g. 1-butene, 1-hexene, 1-dodecene with Ziegler-Natta catalysts). These copolymers have an amorphous structure, which makes them useful for various other applications including but not limited to the production of hot melt adhesives. APAOs have also been used as drag reducing agents.

Suitable hydrocarbon soluble polymers include but are not limited to material such as polyolefins, polyisobutylene, polydimethylsiloxane, polystyrene derivatives, polyacrylates, polybutadiene, polyisopreme, cyclopentene polymers and copolymers of cyclopentene with other ethylenically unsaturated hydrocarbons such as isobutene, octene, butadiene and isoprene. Particularly desirable high molecular weight polymers are non-crystalline, hydrocarbon soluble, polyalphaolefin homopolymers and copolymers in which the olefin monomers contains from 2 to 30 carbon atoms. All of the various high molecular weight polymers and their methods of preparation are well known in the art. For example, U.S. Pat. No. 4,493,903 to Mack, which is incorporated by reference herein, discloses a method for producing ultra-high molecular weight, oil soluble, non-crystalline polymers of alpha olefins.

The polyalphaolefin polymer may be formed using any method known to persons skilled in the art (such as, for example, using the methods disclosed in U.S. Pat. Nos. 3,692,676; 4,289,679; 4,358,572; 4,433,123; 4,493,903; 4,493,904, U.S. Pat. No. 4,384,089; U.S. Pat. No. 4,845,178; U.S. Pat. No. 4,837,249, and/or U.S. Pat. No. 5,449,732 all of which are incorporated herein by reference); In addition, amorphous polyisobutylene (APIB) may be used in accordance with the present description, in place of, or together with APAO. APIB or amorphous polyisobutylene products are currently available under the trade name OPPANOL from BASF in various molecular weights ranging from less than 40000 to more than 5000000 as determined by GPC and in the form of slabs which must be processed prior to application; Or from other suppliers under various trade names.

The presently described compounds (APAO and/or APIB) primarily function as gelling agents and viscosifiers for oil-based drilling and fracturing fluids. That is, these polymers may be added to fluids used to fracture, maintain pressure, cool drill bits, lift cutting from the boreholes in the drilling and fracturing operations for oil and gas wells.

The term “oil-based fluids” as used herein generally refers to fluids having a continuous phase of oil. Should another phase be present to form an emulsion, this other phase would be the discontinuous phase.

Hydrocarbon-based oils suitable for use as solvents with the presently described polymers comprise one or more of the following hydrocarbon solvents: paraffinic hydrocarbons, aromatic hydrocarbons, and naphthenic hydrocarbons. One or more of the oils or solvents may be synthetic. Blends comprising one or more of said oils, and hydrocarbon based alcohol would also be suitable. The oil-based fluids may further contain alcohols, weighting agents, wetting agents, emulsifying agents, and other additives known in the art.

Suitable APAO polymers for use in accordance with the present methods are homopolymers or copolymers derived from alpha olefin monomers. The polymers have an average molecular weight of about 1,000,000 to about 50,000,000, and preferably between about 5,000,000 and 25,000,000.

APAO polymers are added to the oil-based solvent at concentrations of about 25 ppm of polymer to about 100,000 ppm of polymer, and preferably from about 500 ppm to about 10,000 ppm of polymer. Suitable APIB polymer for use in accordance with the present methods have an average molecular weight from about 500,000 to about 10,000,000. Preferably, the polymers have a molecular weight from about 1,000,000 to about 5,000,000. APIB is added to the oil-based fluids in accordance with the present methods, at concentrations from about 250 ppm to about 100,000 ppm. Preferably, APIB is added at concentrations ranging from about 1,000 ppm to about 5,000 ppm.

The molecular weight and polymer concentration required for suitable results will depend on the oil-based hydrocarbon composition selected, and the formation in which the fluid will be used. Such manipulations of downhole fluids based on formation characteristics will be well within the ability of a person skilled in the art, when provided with the teachings of the present description.

### Drilling Fluids

Typical drilling fluids may invade the formation matrix and damage the formation. The water-insoluble APAO polymers readily dissolve in oil-based drilling fluid, reducing the amount of fluid invasion to the formation and would therefore minimize the formation damage tendency of the drilling fluid.

A viscosifier (for example Bentone 150) is typically added to drilling fluids in large quantities. Accordingly, a significant amount of product and labour is involved in the addition of this viscosifier and the mixing process. The present polymers may be added to drilling fluids (as viscosifiers) at much lower quantities rapidly with similar or superior effect. Increasing rheological properties quickly will provide added benefit in situations where an unexpected increase in density is required to control formation pressures.

Often a relatively small volume of fluid is viscosified and circulated to sweep the wellbore clean during a drilling operation. As APAO and/or APIB polymers will quickly increase the rheological properties of an oil based fluid it is a great benefit to use them in oil based fluids to be used as a sweep to be circulated to clean the wellbore or in a fluid to carry loss circulation materials (LCM) to a specific depth.

As these polymers are known to reduce frictional drag in other fluid compositions, the use of APAO and APIB polymers in drilling fluids will reduce operating pump pressures, minimizing the invasion of oil based drilling fluid into the under-pressured formations.

A conventional oil-based drilling fluid formulation may include the following general ingredients: oil (generally various grades of diesel fuel, crude oil, or other distillate fractions), emulsifying agents, wetting agents, water or brine, fluid-loss additives or fluid-loss control agents, weighting agents, and organophilic clays as primary viscosifying agents. Alkali may also be used, preferably lime (calcium hydroxide or calcium oxide), to bind or react with acidic gases (such as CO₂ and H₂S) encountered during drilling in the formation.

Minimally, the present formulations comprise an APAO or APIB polymer and oil. Other solvents or additives may also be present. Typically, the drilling fluid is up to about 100% oil by volume.

The oil employed in the oil-based drilling fluid is generally a diesel fuel, but may be another commercially available hydrocarbon solvent or blend such as kerosene, fuel oils, selected distillate fractions or selected crudes.

Typical, but non-limiting, examples of suitable emulsifiers which can be readily employed are magnesium or calcium soaps of fatty acids. Typical, but non-limiting, examples of a suitable wetting agent which can be readily employed is an alkylaryl sulfonate. Typical, but non-limiting, examples of a weighting materials which can be readily employed is barium sulphate and calcium carbonate. These additives and other are known in the art and readily available.

### Fracturing Fluids

Fracturing fluids for use in accordance with the present invention may include APAO or APIB polymer, organic liquids such as diesel oil or other paraffinic, cyclic, aromatic liquids which can dissolve the subject polymers, other viscosifiers, breaking agents and proppants.

Minimally, the present formulations comprise an APAO or APIB polymer and a solvent. Other solvents or additives may also be present. Typically, the fracturing fluid is up to about 100% oil by volume.

Without being bound to any particular theory, it is contemplated that the APAO and/or APIB polymer viscosified oil-based fracturing fluids such as those described herein will increase and maintain suitable viscosity and rheology to efficiently carry the proppants from the surface to the formation. Due to the APAO and/or APIB polymer structural characteristics, the polymers break down under the high shear and temperature inside the fracturing zone, allowing the fluid inside the fracture to flow back easily, assisting in the cleanup stage. The residual polymer remaining behind in the fracture is dissolved in the producing fluid, thereby significantly reducing the amount of formation damage that might be expected when using other fluids.

In conventional fluids, a high concentration of phosphate/breaking agent is used to achieve required fluid rheology. Fracture conductivity can be impaired by the need to break the gelling agents in the fluids and produce them back to surface. The presently described polymers can partially or totally replace phosphates/breaking agents in the fracturing fluid, achieving sufficient rheology at much lower concentrations compared to the products used in the conventional chemistries currently in use.

Further, the flow of proppants into the wellbore following a fracturing treatment is of major concern using current fluids. This phenomenon may occur during the clean up or when the well is on production. Breaking the polymer at the right time and thereby lowering the viscosity will reduce the amount of proppants carried out into the wellbore during the clean up stage. The APAO and APIB polymers do not require a breaking agent, but naturally break under conditions of high shear, for example at fracturing pressures within the formation. Accordingly, the use of APAO and/or APIB polymers within an oil-based fracturing fluid provides suitable gelling and breaking versatility, while simplifying the completion operation.

It is presently contemplated that fracturing fluids in accordance with the current invention will comprise an oil base which could be diesel fuel and includes other commercially available hydrocarbon solvents such as kerosene, fuel oils, selected distillate fractions, pure or commercial grades or blends of aliphatic or aromatic liquids in which the APAO and/or APIB polymers dissolve or selected crude oils, APAO and/or APIB polymers and usually a proppant. The formulation may or may not contain conventional gelling chemistries such as phosphate esters and gel breakers.

### Examples

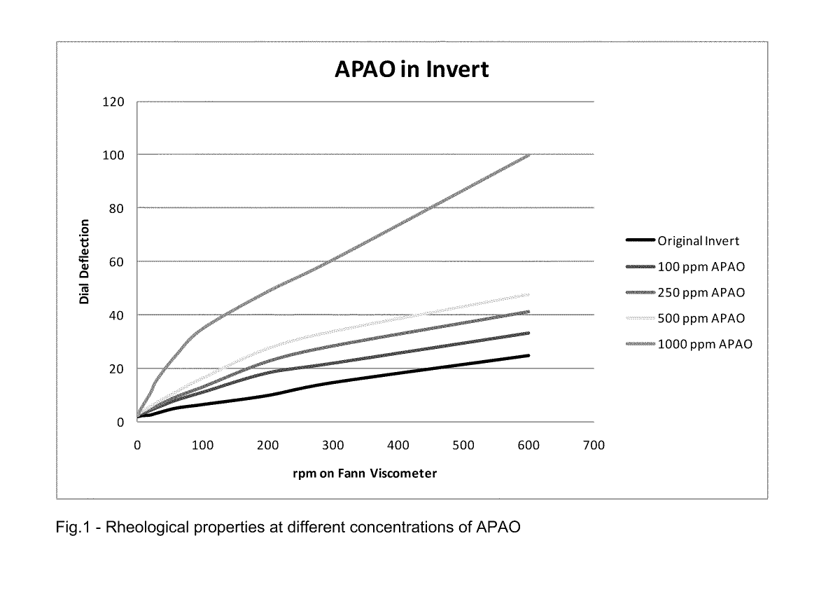

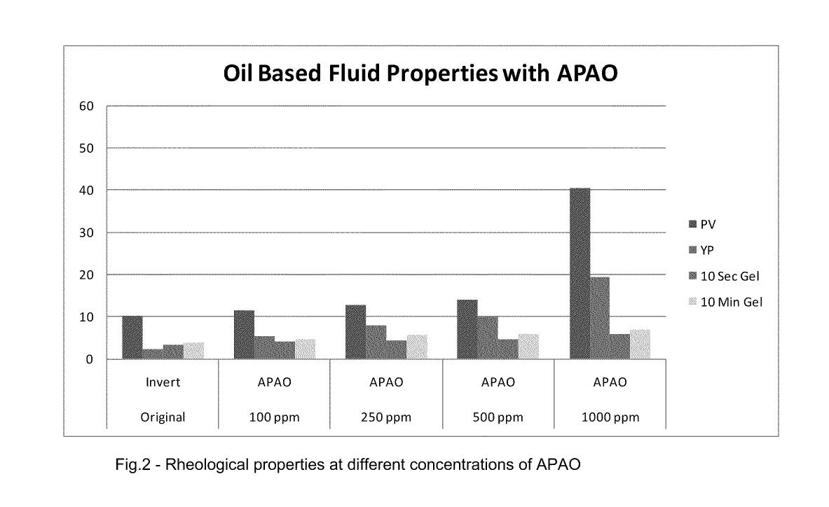

A 90:10 oil:water ratio drilling fluid field sample (containing primary and secondary emulsifier, calcium oxide and bentone) was selected to test the effect of APAO on fluid properties in the laboratory. Varying concentrations of the APAO was mixed into each sample at high shear rate, and the rheological properties were tested using a Fann Viscometer. Table 1, FIG. 1 and FIG. 2 indicate the effect of APAO on the rheology of the oil based drilling fluid.

TABLE 1
Rheological properties at different concentrations of APAO

| | | 100 | | | |
|---|---|---|---|---|---|
| | Original | ppm | 250 ppm | 500 ppm | 1000 ppm |
| Properties | Invert | APAO | APAO | APAO | APAO |
| 600 rpm | 24.8 | 33.4 | 41.2 | 47.8 | 99.9 |
| 300 rpm | 14.7 | 22.1 | 28.4 | 33.9 | 60.8 |
| 200 rpm | 9.9 | 18.4 | 22.6 | 27.5 | 48.9 |
| 100 rpm | 6.5 | 11.1 | 13.1 | 16.3 | 35.0 |
| 60 rpm | 5.2 | 8.2 | 9.5 | 11.2 | 25.3 |
| 30 rpm | 3.3 | 5.3 | 6.0 | 7.2 | 16.0 |
| 20 rpm | 2.6 | 4.3 | 4.9 | 5.7 | 11.0 |
| 10 rpm | 2.4 | 3.3 | 4.0 | 4.2 | 7.0 |
| 6 rpm | 2.3 | 3.0 | 3.4 | 3.7 | 5.4 |
| 3 rpm | 2.1 | 2.9 | 2.9 | 3.2 | 4.0 |
| 2 rpm | 2.1 | 2.8 | 2.7 | 3.0 | 3.4 |
| 1 rpm | 2 | 2.7 | 2.4 | 2.6 | 2.5 |
| PV Mpa * s | 10.1 | 11.4 | 12.8 | 13.9 | 40.5 |
| YP Pa | 2.3 | 5.4 | 7.8 | 10.0 | 19.5 |
| 10 Sec Gel Pa | 3.2 | 4.0 | 4.4 | 4.6 | 5.8 |
| 10 Min Gel Pa | 3.9 | 4.7 | 5.7 | 5.8 | 6.9 |

After the APAO was mixed the rheological properties were measured using a Fann viscometer after 2 full circulations of the fluid were completed. Notable improvements in the Yield Point (an indicator of the carrying capacity of the fluid) were observed, as shown in Table 1. To achieve equivalent increases in YP using conventional viscosification products (for example, bentones) about 50 to 100 times more product by weight (approximately 30-150 kg/m³ of the bentone) would be required, compared to the amount (by weight) of APAO polymer added.

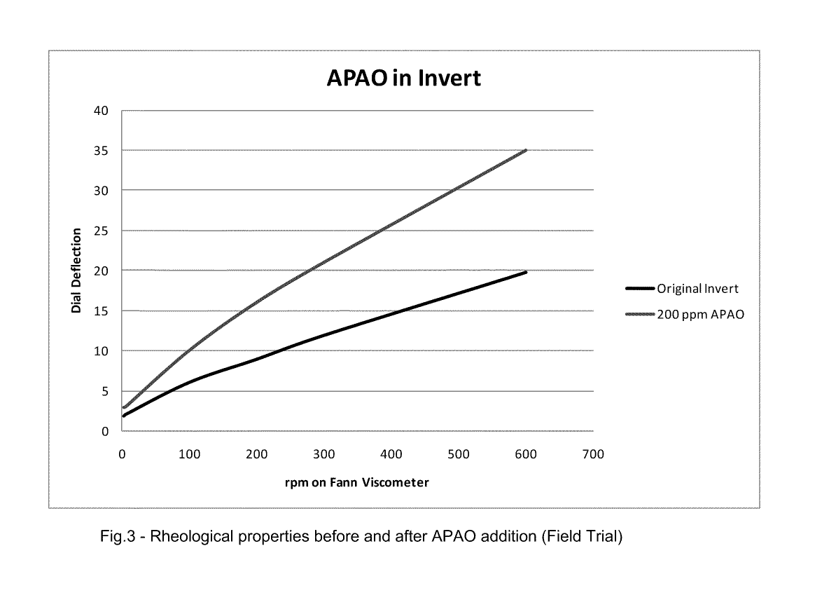

The same formulation as used in the lab sample was used for the field to test the effect of APAO in an oil based fluid under actual operating conditions. 200 ppm of APAO was mixed during drilling at approximately 2000 m measured depth. FIG. 3 reflects the change in rheology observed.

Similar rheological results and comparable advantages have been observed during laboratory and field testing of fracturing fluids described herein.

### Methods

The above-described drilling and fracturing fluids may be used in accordance with known drilling and fracturing methods. No changes or alterations to standard procedures are required. All ranges of viscosity as may be required by the industry are achievable using the fluids described herein.

As is known in this field, the fluids may be adjusted by the operator based on the particular fluid properties deemed desirable for each operation. Generally, laboratory testing is conducted in advance, as necessary.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. An oil-based fluid for use within a wellbore, the fluid comprising:
50 to 100% hydrocarbon-based oil (by volume);
0 to 50% water (by volume); and
25 ppm to 100,000 ppm of amorphous polyalphaolefins (APAO), the APAO having an average molecular weight of between 1,000,000 and 50,000,000.

2. The fluid as in claim 1, wherein the hydrocarbon-based oil comprises paraffinic hydrocarbons, aromatic hydrocarbons, or naphthenic hydrocarbons.

3. The fluid as in claim 1, wherein the hydrocarbon-based oil comprises up to 50% of non-solvent alcohols, vegetable oils or synthetic fluids (by volume).

4. The fluid as in claim 1, wherein the concentration of APAO is between about 500 ppm and about 10,000 ppm.

5. The fluid as in claim 1, wherein the average molecular weight of APAO is between about 5,000,000 and 25,000,000.

6. The fluid as in claim 1, further comprising an amount of amorphous polyisobutylene.

7. The fluid as in claim 1 that is formulated for use as a drilling fluid.

8. The fluid as in claim 7 that is up to 99% hydrocarbon-based oil (by volume).

9. The fluid as in claim 7, further comprising: a weighting material, a wetting agent, or an emulsifier.

10. The fluid as in claim 1 that is formulated for use as a fracturing fluid.

11. The fluid as in claim 10 that is up to 100% hydrocarbon-based oil (by volume)

12. An oil-based fluid for use within a wellbore, the fluid comprising:
50 to 100% hydrocarbon-based oil (by volume);
0 to 50% water (by volume); and
250 ppm to 100,000 ppm of amorphous polyisobutylene (APIB), the APIB having an average molecular weight of between 500,000 and 10,000,000.

13. The fluid as in claim 12, wherein the hydrocarbon-based oil comprises paraffinic hydrocarbons, aromatic hydrocarbons, or naphthenic hydrocarbons.

14. The fluid as in claim 12, wherein the hydrocarbon-based oil comprises up to 50% by volume of non-solvent alcohols, vegetable oils or synthetic fluids.

15. The fluid as in claim 12, wherein the concentration of APIB is between about 500 ppm and about 5,000 ppm.

16. The fluid as in claim 12, wherein the average molecular weight of APIB is between about 1,000,000 and 5,000,000.

17. The fluid as in claim 12 that is formulated for use as a drilling fluid.

18. The fluid as in claim 17 that is up to 99% hydrocarbon-based oil (by volume).

19. The fluid as in claim 17, further comprising: a weighting material, a wetting agent, or an emulsifier.

20. The fluid as in claim 12 that is formulated for use as a fracturing fluid.

21. The fluid as in claim 20 that is up to 100% hydrocarbon-based oil (by volume).

22. A method for increasing the viscosity of an oil-based drilling fluid, the method comprising:
providing an oil-based drilling fluid; and
adding 25 ppm to 100,000 ppm of amorphous polyalphaolefins (APAO), the APAO having an average molecular weight of between 1,000,000 and 50,000,000.

23. A method for increasing the viscosity of an oil based drilling fluid, the method comprising:
providing an oil-based drilling fluid; and
250 ppm to 100,000 ppm of amorphous polyisobutylene (APIB), the APIB having an average molecular weight of between 500,000 and 10,000,000.

24. A method for increasing the viscosity of an oil based fracturing fluid, the method comprising:
providing an oil-based fracturing fluid; and
adding 25 ppm to 100,000 ppm of amorphous polyalphaolefins (APAO), the APAO having an average molecular weight of between 1,000,000 and 50,000,000.

25. A method for increasing the viscosity of an oil based fracturing fluid, the method comprising:
providing an oil-based fracturing fluid; and
adding 250 ppm to 100,000 ppm of amorphous polyisobutylene (APIB) to the fracturing fluid, the APIB having an average molecular weight of between 500,000 and 10,000,000.
